(19) United States
(12) Patent Application Publication
(10) Pub. No.: US 2018/0344094 A1
(43) Pub. Date: Dec. 6, 2018

(54) Outdoor Cooking Device

(71) Applicant: Kevin Feather, Bedford, PA (US)

(72) Inventor: Kevin Feather, Bedford, PA (US)

(21) Appl. No.: 15/997,010

(22) Filed: Jun. 4, 2018

Related U.S. Application Data
(60) Provisional application No. 62/515,866, filed on Jun. 6, 2017.

(51) Int. Cl. A47J 43/28; A47J 33/00; A47J 43/18; F21V 33/00

(52) U.S. Cl. CPC A47J 43/283; A47J 33/00; F21V 33/0084; F21V 33/0036; A47J 43/18

(57) ABSTRACT

An outdoor cooking device for preparing food over an open fire. More specifically, the device includes a cooking chamber having a pair of elongated arms, and a pair of removable handles with light sources disposed therein to provide additional light focused in the direction of the cooking chamber. Additionally, the light sources disposed in the removable handles allow the handles to convert into flashlights when detached form the elongated arms.

### CROSS REFERENCE TO RELATED APPLICATION

This application claims the benefit of U.S. Provisional Application No. 62/515,866 filed on Jun. 6, 2017. The above identified patent application is herein incorporated by reference in its entirety to provide continuity of disclosure.

### BACKGROUND OF THE INVENTION

The present invention relates to food preparation in an outdoor environment. More specifically, the present invention provides a tool for cooking food over an open fire at night in a camping setting where visibility is poor.

Cooking around a campfire normally happens late in the day when visibility from the sun is minimal or non-existent. Often the only available light source is the campfire itself, which can be difficult to leverage as a light source while already being used a heat source to cook the food. Even when secondary light sources are available they can be very difficult to maneuver into useful position without help from others. Attempting to hold a cooking device over an open fire in one hand, while using the other hand to operate a flashlight to provide additional visibility for the cooking process is cumbersome, inefficient, and prone to accidents. The present invention provides a cooking tool with integrated lighting preset to shine light directly onto the cooking device being used to prepare the food, thereby providing additional visibility without difficulty of managing a cooking device in one hand and a light source in the other.

Devices have been disclosed in the known art that relate to integrated lighting tools and to outdoor food preparation. These include devices that have been patented and published in patent application publications. These devices generally relate to construction tools like screwdrivers having integrated lighting built into the handle portion, or to portable grills that can be used to prepare food in an outdoor setting. However, none of these devices provide a tool having an integrated light source for cooking in an outdoor environment.

In light of the devices disclosed in the known art, it is submitted that the present invention substantially diverges in design elements from the known art and consequently it is clear that there is a need in the art for an improvement to existing outdoor cooking devices. In this regard the instant invention substantially fulfills these needs.

### SUMMARY OF THE INVENTION

In view of the foregoing disadvantages inherent in the known types of outdoor cooking devices now present in the art, the present invention provides a new cooking device wherein the same can be utilized for providing convenience for the user when preparing food over an open fire with insufficient lighting.

It is therefore an object of the present invention to provide a new and improved outdoor cooking device that has all of the advantages of the known art and none of the disadvantages.

It is another object of the present invention to provide a cooking chamber including a first housing hingedly connected to a second housing, such that the two ends rotate inward to close together and rotate outward to open apart.

Another object of the present invention is to provide a pair of elongated arms operably attached to the first and second housings of a cooking chamber, such that both elongated arms can be used to open and close the ends of the cooking chamber.

An additional object of the present invention is to provide a pair of handles disposed on the ends of a pair of elongated arms, that have been sized and proportioned to house a light source configured to provide additional lighting around the cooking chamber while being used to prepare food over an open.

Yet another object of the present invention is to provide cooking chamber configured to flip over, such that the positions of the first housing and second are reversed, without spilling any food items while the two ends are closed together and held together over an open fire.

Another object of the present invention is to provide an outdoor cooking device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of an outdoor cooking device in the open position.

FIG. 2A shows a top plan view of an embodiment of an outdoor cooking device in the closed position.

FIG. 2B shows a left side view of an embodiment of an outdoor cooking device in the closed position.

FIG. 3A shows a perspective view of an embodiment of a handle for an outdoor cooking device in the open position.

FIG. 3B shows a cross-sectional view along line AA′ of an embodiment of a handle for an outdoor cooking device in the open position.

### DETAILED DESCRIPTION OF THE INVENTION

Reference is made herein to the attached drawings. Like reference numerals are used throughout the drawings to depict like or similar elements of the outdoor cooking device. For the purposes of presenting a brief and clear description of the present invention, the preferred embodiment will be discussed as used for preparing food outdoors over an open flame in an environment with poor lighting and visibility. The figures are intended for representative purposes only and should not be considered to be limiting in any respect.

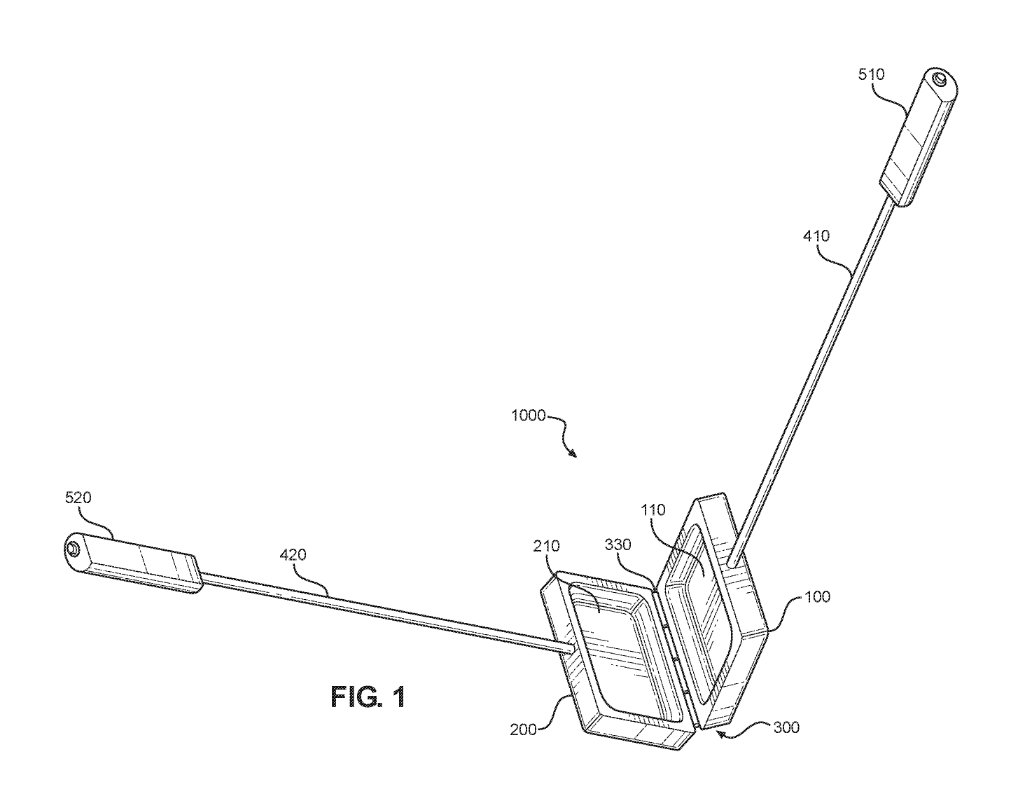

Referring now to FIG. 1, there is shown a perspective view of an embodiment of an outdoor cooking device in the open position. The outdoor cooking device 1000, comprises a cooking chamber 300 made from a heat conductive material. Where the cooking chamber 300 includes a first housing 100 connected to a second housing 200 by a hinged connection 330, such that he first housing 100 and second housing are configured to rotate about the hinged connection 330. The two ends 100, 200 can rotate inward until they are physically pressed together in the closed position, and they can rotate outward and away from each other to enter the open position.

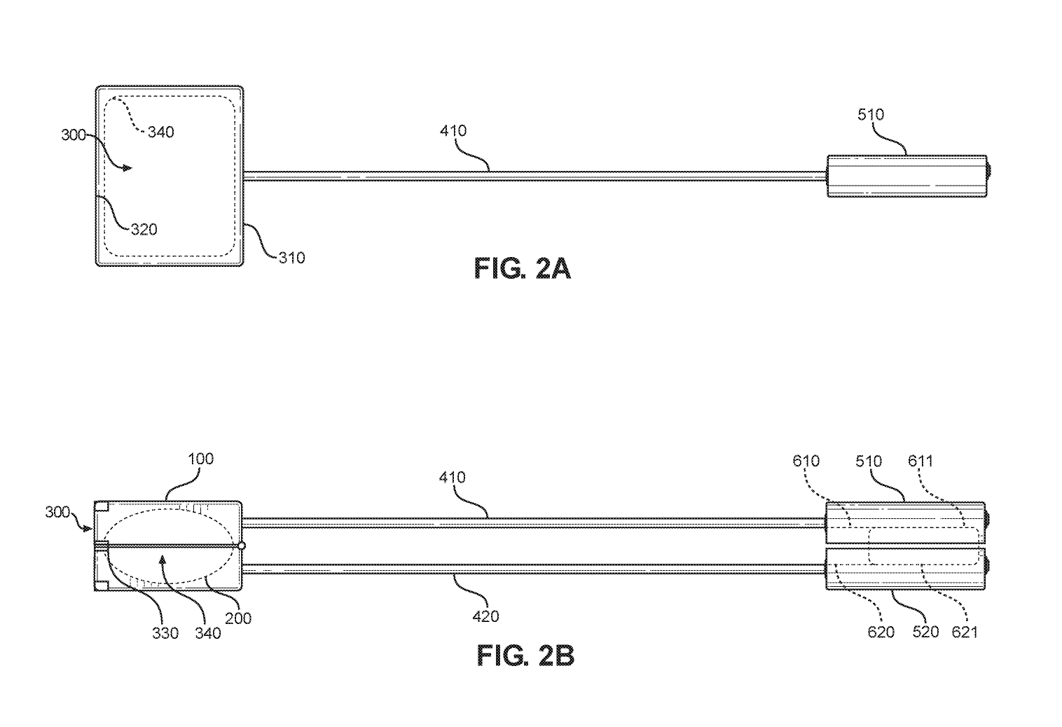

In the illustrated embodiment, the first housing 100 and the second housing 200 of the cooking chamber 300 both have recessed inner chambers 110, 210, that cooperatively form a sealed interior volume 340 (see FIG. 2B) when the two ends 100, 200 are closed together. In the shown embodiment, the recessed inner chambers 110, 210 are entirely enclosed by a sidewall of the respective housing 100, 200 that extends and forms a flat surface oriented towards the opposing housing 100, 200. The cooking chamber 300 further includes a proximal side 310 and a distal side 320 (see FIG. 2A), such that a hinged connection 330 between the first housingfirst housing 100 and the second housing 200 is disposed along the distal side 320. Additionally, a pair of elongated arms 410, 420 are operably connected to the proximal side 310 of the cooking chamber 300, such that the first elongated arm 410 extends outward from the first housing 100 of the cooking chamber 300 to a first removable handle 510, and the second elongated arm 420 extends outward from the second housing 200 of the cooking chamber 300 to a second removable handle 520.

Referring now to FIGS. 2A and 2B, there are shown a top plan view and a left side view of an embodiment of an outdoor cooking device in the closed position, respectively. In the illustrated embodiment, the first elongated arm 410 is configured to open and close the cooking chamber 300 via the connection to the proximal side 310 of the first housing 100. Similarly, the second elongated arm 420 is configured to open and close the cooking chamber 300 via the connection to the proximal side 310 of the second housing 200. The handles 510, 520 are made from heat resistant materials and disposed on the ends of the elongated arms 410, 420 to provide insulation while holding the cooking chamber 300 over a heat source, such as an open fire. The sealed interior volume 340 is configured to receive and securely house food items inserted therein. Once a food item is inserted into the interior volume 340 of the cooking chamber 300, the handles 510, 520 and the elongated arms 410, 420 can hold the cooking chamber over an open fire until the inserted food item is fully cooked. Additionally, when in the closed position the cooking chamber 300 is configured to securely house an inserted food item without spilling any contents while being maneuvered over an open fire. For example, the cooking chamber 300 can be inverted such that the positions of the first housing 100 and second housing 200 are reversed.

Furthermore, the rotational range of motion of both the first housing 100 and the second housing 200 about the hinged connection 330 is unrestricted, such that the two ends can rotate outward and away from each other past 180° and then continue rotating toward one another until the two ends are physically pressed together, such that inner surface 110 of the first housing 100 and the inner surface 210 of the second housing 200 are exposed and facing outward. In the shown embodiment, the recessed chambers 110, 210 of the housings 100, 200 are identical in dimension and relative location, such that the pair of inner faces of the sidewalls of the recessed chambers 110, 210 forms a coextensive surface therewith.

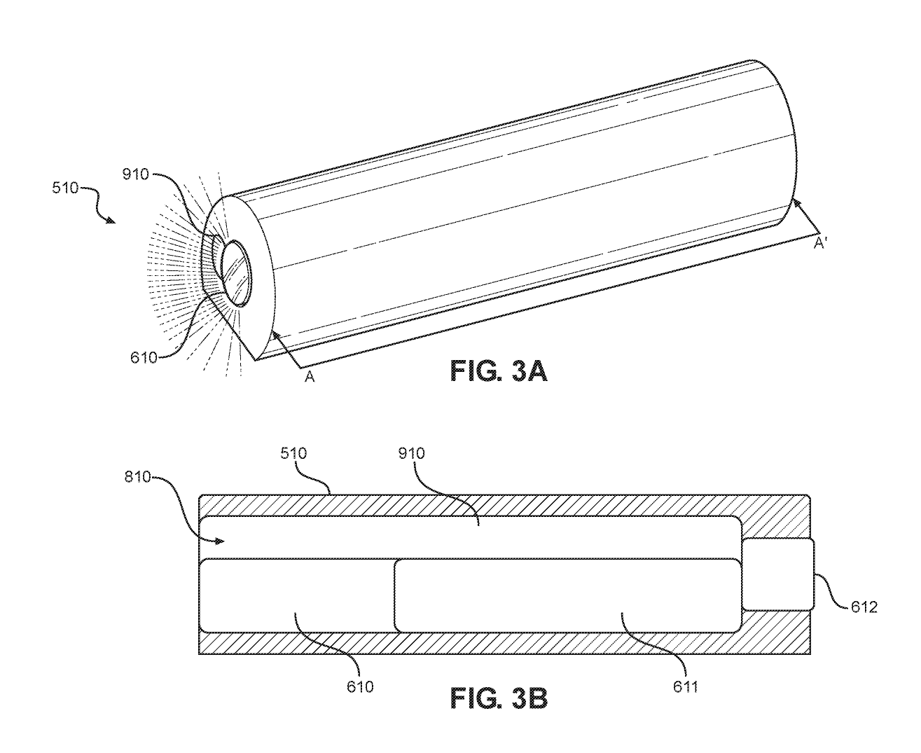

Referring now to FIGS. 3A and 3B, there are shown a perspective view and a cross-sectional view along line AA′ of an embodiment of a handle for an outdoor cooking device in the open position, respectively. In the illustrated embodiment the first removeable handle 510 further includes a first open interior volume 810 that has been sized and proportioned to house a first light source 610 operably connected to a power source 611 and a power switch 612. The first light source 610 is configured to project light back toward the cooking chamber 300 to provide additional light while preparing food over an open fire in a low visibility outdoor setting. Additionally, the open interior volume 810 further includes a first channel 910 configured to receive the end portion of first elongated arm 410, which is sized and proportioned to be removably inserted therein. The removable first handle 510 is further configured to convert into a flashlight upon detachment from the first elongated arm 410. In one embodiment, both the first handle 510 and the second handle 520 include a planar side configured to allow the two handles and the corresponding housings 100, 200 to press together when in the closed position such that the cooking chamber 300 is fully sealed.

Similarly, the second removable handle 520 also includes a second open interior volume 820 that has been sized and proportioned to house a second light source 620 operably connected to a power source 621 and a power switch 622, such that the second light source 620 is also configured to project light back toward the cooking chamber 300. The open interior volume 820 in the removable second handle 520 also includes a second channel 920 configured to receive the end portion of the second elongated arm 420, which is sized and proportioned to be removably inserted therein, such that the removable second handle 520 is further configured to convert into a flashlight upon detachment from the second elongated arm 420.

Furthermore, the first light source 610 and second light source 620 are generated by a plurality of light emitting diodes, and the power source 611 is provided by a rechargeable lithium battery. In other embodiments the light sources 610, 610 can be provided by incandescent light bulbs or fluorescent light bulbs, and the powers source 611 can be provided by traditional non-rechargeable batteries to lower production costs.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An outdoor cooking device, comprising:
a cooking chamber including a first housing hingedly connected to a second housing at a hinged connection, such that the two housings rotate inward to close together and rotate outward to open apart;
the first housing and the second housing both have recessed inner surfaces, such that the two housings close together to form a sealed interior volume configured to securely house and heat food items over a heat source;
each housing further including a proximal side and a distal side, such that the hinged connection between the first housing and the second housing is disposed along the distal side, a first elongated arm is operably connected to the proximal side of the first housing, and a second elongated arm is operably connected to the proximal side of the second housing;
a first handle is disposed on the end of the first elongated arm and a second handle is disposed on the end of the second elongated arm, such that the first handle is configured to insulate the first elongated arm and the second handle is configured to insulate the second elongated arm while holding the cooking chamber over the heat source;
the first handle further including a first light source operably connected to a first power source and a first power switch, disposed in the first handle, and configured to project light toward the cooking chamber.

2. The outdoor cooking device of claim 1, wherein both the first handle and the second handle each include an interior volume configured to house a light source operably connected to a power source and a power switch.

3. The outdoor cooking device of claim 2, wherein a second light source is operably connected to a second power source and a second power switch, second light source disposed in the second handle, and configured to project light back toward the cooking chamber.

4. The outdoor cooking device of claim 3, wherein the first and second light sources are generated by a plurality of light emitting diodes.

5. The outdoor cooking device of claim 4 wherein the first handle is removably attached to the first elongated arm, and the second handle is removably attached to the second elongated arm.

6. The outdoor cooking device of claim 5 wherein the first handle converts into a flashlight upon detachment from the first elongated arm, and the second handle converts into a flashlight upon detachment from the second elongated arm.

7. The outdoor cooking device of claim 1, wherein the rotational range of motion of the first housing about the hinged connection is freely rotatable, such that the inner surface of the first housing and the inner surface of the second housing are exposed and facing outward.

8. The outdoor cooking device of claim 1, wherein the rotational range of motion of the second housing about the hinged connection is freely rotatable, such that the inner surface of the second housing and the inner surface of the first housing are exposed and facing outward.

9. The outdoor cooking device of claim 1, wherein the elongated first arm is configured to open and close the cooking chamber via the connection to the proximal side of the first housing.

10. The outdoor cooking device of claim 1, wherein the elongated second arm is configured to open and close the cooking chamber via the connection to the proximal side of the second housing.

11. The outdoor cooking device of claim 1, wherein the cooking chamber is comprised of a heat conductive material.

12. The outdoor cooking device of claim 1, wherein the cooking chamber is configured to flip over, such that the positions of the first housing and second housing are reversed, without spilling any food items disposed within the cooking chamber while the two housings are closed together.
